(19) United States
(12) Patent Application Publication
(10) Pub. No.: US 2012/0086341 A1
(43) Pub. Date: Apr. 12, 2012

(54) ALTERNATING CURRENT LED ILLUMINATION APPARATUS

(75) Inventors: SHENG-HSIANG KUNG, Chu-Nan (TW); CHIH-MING LAI, Chu-Nan (TW)

(73) Assignee: FOXSEMICON INTEGRATED TECHNOLOGY, INC., Chu-Nan (TW)

(21) Appl. No.: 13/300,628

(22) Filed: Nov. 20, 2011

Related U.S. Application Data
(66) Substitute for application No. 12/901,561, filed on Oct. 10, 2010, now abandoned.

(51) Int. Cl. H01J 7/24

(52) U.S. Cl. 315/113

(57) ABSTRACT

An alternating current light emitting diode (LED) illumination apparatus includes a heat dissipation plate, a plurality of LED chips, a circuit layer, an encapsulation, at least one electrode located on the heat dissipation plate, and a driving element. The LED chips are categorized into at least two LED chip groups connected in series, and each LED chip group comprises at least two LED chips connected in anti-parallel. The driving element comprises a transformer and a bilateral switch. One end of a first switch of the bilateral switch selectively connects to an output terminal of the transformer to output a selected driving voltage to the LED chips. One end of a second switch of the bilateral switch connects to the first switch and the other end of the second switch selectively connects to a LED chip group or all of the LED chips.

### BACKGROUND

1. Technical Field

The present disclosure generally relates to light emitting diode illumination, and particularly to an alternating current light emitting diode illumination apparatus.

2. Description of the Related Art

Light emitting diodes (LEDs) have many advantages, such as high luminosity, low operational voltage, low power consumption, compatibility with integrated circuits, easy driving, long-term reliability, and environmental friendliness, which have promoted the LEDs as a widely used light source. Light emitting diodes are commonly applied in lighting applications.

Luminous intensity of LEDs is in direct proportion to the working current, and thus, commonly, are driven only by direct current (DC). However, luminous efficiency decreases with increased working current. Accordingly, junction temperature of the LED increases with the increase in working current. It is well known that the lifetime of the LED will decrease with the increasing junction temperature of LED. In order to decrease the heat generated by LEDs during operation, Pulse Width Modulation Dimming (PWM Dimming) is commonly applied to control the on/off status of the LED. However, the PWM Dimming operates at a constant current. Thus, the driving circuit of LED has to include at least one AC (alternating current) to DC (direct current) converter. This decreases the utilization efficiency of the LED illumination apparatus and increases manufacturing costs.

What is needed, therefore, is an alternating current LED illumination apparatus which can improve electricity utilization efficiency of LED illumination apparatus, and ameliorate the described limitations.

### BRIEF DESCRIPTION OF THE DRAWINGS

Many aspects of the disclosure can be better understood with reference to the drawings. The components in the drawings are not necessarily drawn to scale, the emphasis instead being placed upon clearly illustrating the principles of the AC LED illumination apparatus. Moreover, in the drawings, like reference numerals designate corresponding parts throughout the views.

FIG. 1 is a schematic view of an AC LED illumination apparatus in accordance with a first embodiment.

FIG. 2 is a schematic view of a circuit of the AC LED illumination apparatus of FIG. 1.

FIG. 3 is a schematic view of a circuit of an AC LED illumination apparatus in accordance with a second embodiment.

### DETAILED DESCRIPTION

Embodiments of an AC LED illumination apparatus as disclosed are described in detail here with reference to the drawings.

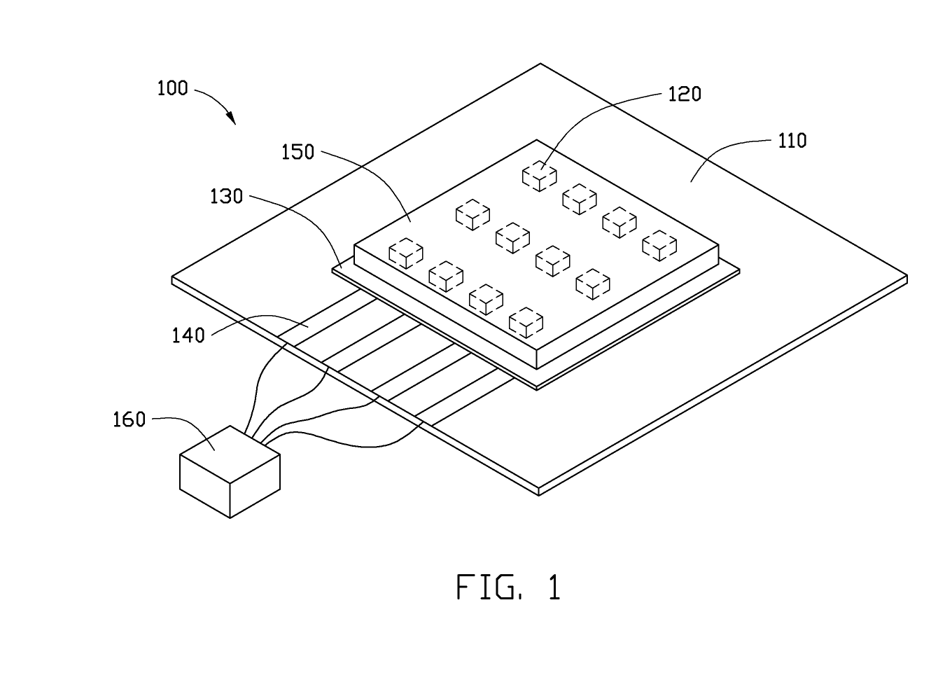

Referring to FIG. 1, an AC LED illumination apparatus 100 includes a heat dissipating plate 110, a plurality of LED chips 120, a circuit layer 130, four electrodes 140, an encapsulation 150, and a driving element 160.

The heat dissipating plate 110 can be highly thermally conductive and electrically insulating, such as Si₃N₄, SiC, ZrO₂, B₄C, TiB₂, AlₓO_{y}, AlN, BeO, or a combination thereof. Moreover, the heat dissipating plate 110 can be an electrically conductive substrate coated with electrically insulating material.

The plurality of LED chips 120 is mounted on one surface of the heat dissipating plate 110 and thermally connects to the heat dissipating plate 110.

The circuit layer 130 can be deposited on the heat dissipating plate 110 by chemical vapor deposition or sputtering. The positive and negative electrodes (not shown) of each LED chip 120 electrically connect to the circuit layer 130. The electrodes 140 are mounted on the heat dissipating substrate 110. In this embodiment, the electrodes 140 are mounted on the surface of the heat dissipating substrate 110 having the LED chips 120 thereon. The electrodes 140 contain four electrical contacts and electrically connect to the circuit layer 130.

The encapsulation layer 150 covering the plurality of LED chips 120 and a part of the circuit layer 130 is mounted on the heat dissipating substrate 110. The electrodes 140 are exposed outside of the encapsulation layer 150. The encapsulation 150 can be silicone, epoxy resin, PMMA (polymethyl methacrylate), or plastic transparent material. The encapsulation 150 can be doped with at least one fluorescent material, such as sulfide, aluminates, oxides, silicate, or nitride. The commonly used fluorescent material is YAG (yttrium aluminum garnet), or TAG (terbium aluminum garnet).

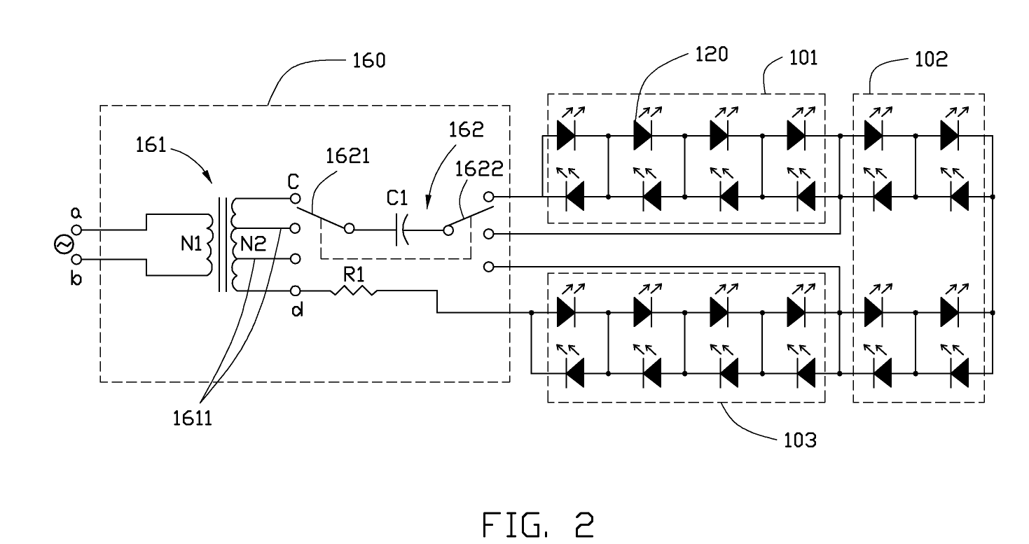

Referring to FIG. 2, the driving element 160 includes a transformer 161 and a bilateral switch 162. The transformer 161 has a primary coil N1 and a secondary coil N2. The two ends a, b of the primary coil N1 are the input terminal of the transformer 161 connecting to an AC power source. The voltage of the AC power source is usually 100V-230V. Between the two ends c, d of the secondary coil N2 have a plurality of tappings 1611. The two ends c, d of the secondary coil N2 and the tapping 1611 form the output terminal of the transformer 161. The bilateral switch 162 includes a first switch 1621 near the transformer 161 and a second switch 1622 near the plurality of LED chips 120. One end of the first switch 1621 selectively connects to any one of the tapping 1611 or end c of the secondary coil N2. The other end of the first switch 1621 connects to a capacitor C1. The unoccupied end of the capacitor C1 connects to one end of the second switch 1622, and the other end of the second switch 1622 selectively connects to a part or all of the plurality of LED chips 120. The end d of the secondary coil N2 connects to a resistor R1. The unoccupied end of the resistor R1 and the ends of the second switch 1622 connecting to the LED chips 120 connect to the electrodes 140 of the heat dissipating plate 110 as output terminal of the driving element 160 and provide driving voltage to the plurality of LED chips 120.

The first switch 1621 adjusts a magnitude of the driving voltage input to the LED chips 120. The second switch 1622 adjusts the number of the LED chips 120 to be driven by the driving voltage. When the coil numbers between each two ends of the secondary coil N2 (i.e., the end c and its adjacent tapping 1611, the two tappings 1611, the end d and its adjacent tapping 1611) is reduced, the adjustable magnitude of the driving voltage between the each two ends is reduced, whereby the first switch 1621 can achieve a more smooth adjustment of the intensity of the light emitted by the LED chips 120.

In this embodiment, the plurality of LED chips 120 includes a first LED chip group 101, a second LED chip group 102, and a third LED chip group 103. The LED chips 120 are connected first in anti-parallel with every two chips and then connected in series. In other words, the LED chips 120 are divided into a plurality of pairs. Twelve pairs are shown in FIG. 2. The two LED chips 120 of each pair are connected anti-parallel. The twelve pairs are connected in series with each other. The two ends of the three LED chip group 101, 102, and 103, the node between the first LED chip group 101 and the second LED chip group 102, and the node between the second LED chip group 102 and the third LED chip group 103 are respectively connected to the four electrical contacts of the electrode 140.

The driving element 160 of the AC LED illumination apparatus 100 connects directly to the AC power to drive the plurality of LED chips 120. The first switch 1621 of the bilateral switch 162 of the driving element 160 adjusting the driving voltage of the plurality of LED chips 120 is simpler than the common driving circuit. Furthermore, the AC LED illumination apparatus 100 does not require any AC-DC converters. Thus, the power utilization efficiency of the AC LED illumination apparatus 100 increases.

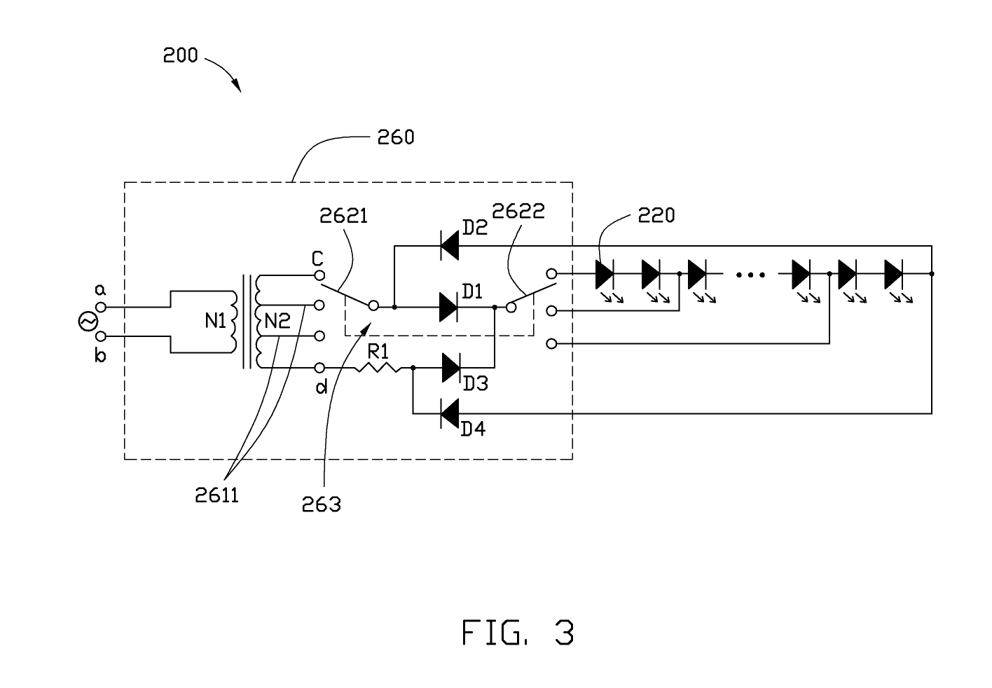

Referring to FIG. 3, an AC LED illumination apparatus 200 of a second embodiment is similar to the AC LED illumination apparatus 100. The AC LED illumination apparatus 200 includes a plurality of LED chips 220 connected in series, and a driving element 260 with a bilateral switch 2262 comprising a first switch 2621 near a transformer 261 and a second switch 2622 near the plurality of LED chips 220. The input terminal of the first switch 2621 selectively connects to an end c or any tapping 2611 of the secondary coil N2. The output terminal of the second switch 2622 selectively connects to a part or all of the plurality of LED chips 220. A forward connecting first LED D1 is connected in series between the output terminal of the first switch 2621 and the input terminal of the second switch 2622. A backward connecting second LED D2 is connected in series between the output terminal of the first switch 2621 and the negative electrode end of the plurality of LED chips 220. A forward connecting third LED D3 is connected in series between the end d of the secondary coil N2 of the transformer 261 and the input terminal of the second switch 2622. A backward connecting fourth LED D4 is connected in series between the end d of the secondary coil N2 of the transformer 261 and the negative electrode end of the plurality of LED chips 220. The forward or backward voltage output from the transformer 261 become forward voltage for the plurality of LED chips 220.

It is to be understood, however, that even though numerous characteristics and advantages of the disclosure have been set forth in the foregoing description, together with details of the structures and functions of the embodiment(s), the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. An AC LED illumination apparatus, comprising:
a heat dissipating plate;
a plurality of LED chips arranged on and thermally connected to the heat dissipating plate, the plurality of LED chips categorized into at least two LED chip groups connected in series, and each LED chip group comprising at least two LED chips connected in anti-parallel;
a circuit layer arranged on the heat dissipating plate and electrically connected to the plurality of LED chips;
an encapsulation covering the plurality of LED chips and a part of the circuit layer;
at least one electrode mounted on the heat dissipating plate and exposed out of the encapsulation; and
a driving element including a transformer and a bilateral switch, wherein the transformer has an input terminal and an output terminal, the input terminal is configured to connect to an alternating current (AC) power source, the output terminal is electrically connected to the at least one electrode of the heat dissipating plate by the bilateral switch, the bilateral switch includes a first switch near the transformer and a second switch near the plurality of LED chips, one end of the first switch selectively connects to the output terminal of the transformer to output a selected one of different driving voltages to the LED chips, one end of the second switch connects to the first switch, and the other end of the second switch selectively connects to the LED chips in one of the two modes: one of the at least two LED chip groups and all of the LED chips.

2. The AC LED illumination apparatus of claim 1, wherein a capacitor is connected in series between the first switch and the second switch.

3. The AC LED illumination apparatus of claim 1, wherein a resistor is connected in series between the first switch and the plurality of LED chips.

4. The AC LED illumination apparatus of claim 1, wherein the at least one electrode includes four electrical contacts, the plurality of LED chips categorized into three LED chip groups each with every two LED chips connected in anti-parallel first and then connected in series, two ends of the three LED chip groups, the node of the first LED chip group connecting to the second LED chip group, and the node of the second LED chip group connecting to the third LED chip group are respectively connecting to the four electrical contacts of the electrode.

5. An AC LED illumination apparatus, comprising:
a heat dissipating plate;
a plurality of LED chips connected in series arranged on and thermally connected to the heat dissipating plate;
a circuit layer arranged on the heat dissipating plate and electrically connected to the plurality of LED chips;
an encapsulation covering the plurality of LED chips and a part of the circuit layer;
at least one electrode including three electrical contacts mounted on the heat dissipating plate and exposed out of the encapsulation; and
a driving element including a transformer and a bilateral switch, wherein the transformer has an input terminal and an output terminal, the input terminal is configured to connect to an alternating current (AC) power source, the output terminal is electrically connected to the electrode of the heat dissipating plate by the bilateral switch, the bilateral switch includes a first switch near the transformer and a second switch near the plurality of LED chips, input terminal of the first switch selectively connects to the output terminal of the transformer to output different driving voltage to the LED chips, output terminal of the second switch selectively connects to a part or all of the LED chips, a forward connecting first LED is connected in series between the output terminal of the first switch and the input terminal of the second switch, a backward connecting second LED is connected in series between the output terminal of the first switch and the negative electrode end of the plurality of LED chips, a forward connecting third LED is connected in series between the output terminal of the transformer and the input terminal of the second switch, and a backward connecting fourth LED is connected in series between the output terminal of the transformer and the negative electrode end of the plurality of LED chips.
